(19) United States
(12) Patent Application Publication
(10) Pub. No.: US 2022/0172451 A1
(43) Pub. Date: Jun. 2, 2022

(54) Method For Defining An Outline Of An Object

(71) Applicant: ABB Schweiz AG, Baden (CH)

(72) Inventor: Jonatan Blom, Sundbyberg (SE)

(21) Appl. No.: 17/594,272

(22) PCT Filed: Apr. 15, 2019
(86) PCT No.: PCT/EP2019/059640

§ 371 Date: Oct. 8, 2021

(51) Int. Cl. G06V 10/44; G06T 7/194

(52) U.S. Cl. CPC G06V 10/44; G06T 2207/20092; G06T 7/194

(57) ABSTRACT

A method for defining an outline of an object includes the steps of: placing the object on a display; highlighting a non-obstructed pixel on the display; highlighting an obstructed pixel on the display; and capturing a first image of the display. The non-obstructed pixel being visible in the first image and the obstructed pixel not being visible in the first image, which information is used to define at least a part of the outline based on the location of the non-obstructed pixel alone, based on the location of the obstructed pixel alone, or based on the locations of the non-obstructed pixel and the obstructed pixel. The outline definition is thereby based on on/off signals i.e., whether or not individual pixels whose positions on the display are known and are visible, rather than on gradients on an image.

### TECHNICAL FIELD

The present invention relates to identifying objects and their positions particularly in robot applications.

### BACKGROUND

Vision systems are widely used in industrial automation solutions to detect and determine positions of various objects. Conventional vision systems are typically based on contour recognition algorithms enabling distinction of an object from the background on the basis of gradients on an image. The accuracy of a detected contour of the object depends on the performance of the respective algorithm which may vary in dependence on external factors like lighting conditions. A vision system is typically an optional part of robot system, adding cost to the overall robot system.

There remains a desire to provide an improved method for defining an outline of an object.

### SUMMARY

One object of the invention is to provide an improved method for defining an outline of an object. In particular, one object of the invention is to provide a method which is less sensitive than conventional vision systems to external conditions.

A further object of the invention is to provide an improved vision system for robot applications. In particular, a further object of the invention is to provide a vision system which enables the use of simple and robust contour recognition algorithms.

These objects are achieved by the method and the device according to the appended claims.

The invention is based on the realization that an outline definition of an object can be based on on/off signals rather than on gradients on an image by detecting visibility of individual pixels whose positions on a display are known.

According to a first aspect of the invention, there is provided a method for defining at least a part of an outline of an object. The method comprises the steps of: placing the object on a display; highlighting a non-obstructed pixel on the display; highlighting an obstructed pixel on the display; and capturing a first image of the display, the non-obstructed pixel being visible in the first image and the obstructed pixel not being visible in the first image. At least a part of the outline is defined based on the location of the non-obstructed pixel alone, based on the location of the obstructed pixel alone, or based on the locations of the non-obstructed pixel and the obstructed pixel.

By basing the definition of the outline on visibility of individual pixels the method becomes robust in that each observed part of the first image can only obtain two discrete values. It is to be understood that it is not known in advance whether a highlighted pixel is a non-obstructed pixel or an obstructed pixel as this is found out only after analysing the first image.

According to one embodiment of the invention the method comprises the step of determining that the outline passes between the non-obstructed pixel and the obstructed pixel, or traverses one of the non-obstructed pixel and the obstructed pixel.

According to one embodiment of the invention the method comprises the steps of de-highlighting the non-obstructed pixel and capturing a second image of the display, the obstructed pixel not being visible in the second image. De-highlighting the non-obstructed pixel enables highlighting the obstructed pixel in relation to it; it may not be possible to simultaneously highlight two pixels that lie close to each other.

According to one embodiment of the invention the non-obstructed pixel and the obstructed pixel are next to each other. By this provision the outline is obtained at one pixel's accuracy, the maximum accuracy according to the present invention.

According to one embodiment of the invention the method comprises the steps of highlighting an intermediate pixel between the non-obstructed pixel and the obstructed pixel; capturing a third image of the display; and determining, on the basis of the third image, whether the intermediate pixel is a non-obstructed pixel or an obstructed pixel. By determining the visibility of the intermediate pixels the accuracy of the defined outline can be improved until there are no intermediate pixels between any pair of a non-obstructed pixel and an obstructed pixel.

According to one embodiment of the invention the method comprises the step of defining at least a part of the outline based on the locations of a plurality of non-obstructed pixels alone, based on the locations of a plurality of obstructed pixels alone, or based on the locations of a plurality of non-obstructed pixels and a plurality of obstructed pixels.

According to one embodiment of the invention the method comprises the step of obtaining a vision outline of the object by means of a conventional contour recognition algorithm.

According to one embodiment of the invention the method comprises the steps of highlighting, in a sequence comprising a plurality of operations, all the pixels; capturing an image of the display during each operation to obtain a plurality of images; and determining for each pixel, on the basis of the plurality of images, whether it is a non-obstructed pixel or an obstructed pixel.

According to a second aspect of the invention, there is provided a vision system comprising a tablet computer with a display having a plurality of pixels arranged in respective rows and columns. A camera is arranged in a fixed position in relation to the display. The vision system further comprises a mirror, and a fixture defining a fixed relative position between the tablet computer and the mirror. The vision system is configured to capture images of the display via the mirror.

According to one embodiment of the invention the vision system is configured to capture images of the whole display.

According to a third aspect of the invention, there is provided a robot system comprising an industrial robot and any of the aforementioned vision systems.

### BRIEF DESCRIPTION OF THE DRAWINGS

The invention will be explained in greater detail with reference to the accompanying drawings, wherein

FIG. 1 shows a vision system according to one embodiment of the invention,

FIG. 2 shows a tablet computer with an object placed on its display and with an array of pixels highlighted, and

FIG. 3 shows a magnification of a detail in FIG. 2.

### DETAILED DESCRIPTION

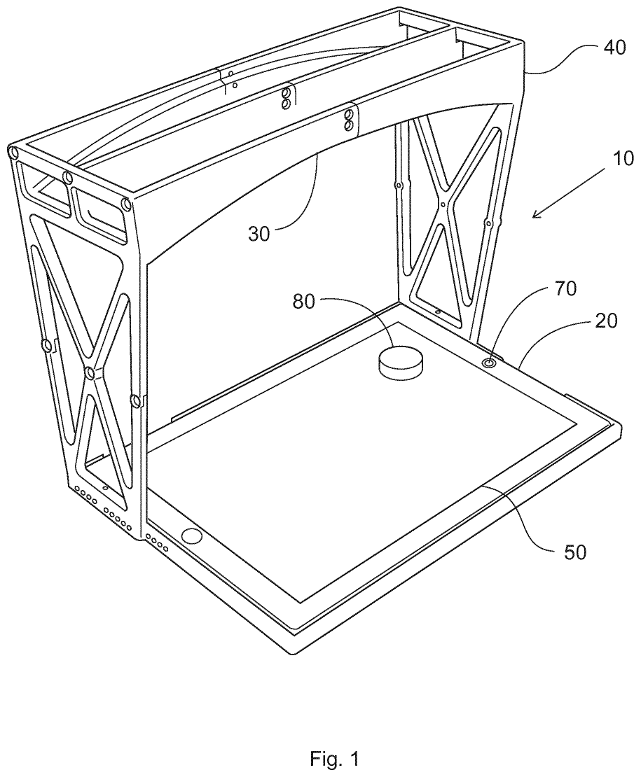

Referring to FIG. 1, a vision system 10 according to one embodiment of the present invention comprises a tablet computer 20, a mirror 30 and a fixture 40 defining a fixed relative position between the tablet computer 20 and the mirror 30. The tablet computer 20 comprises a display 50 with a plurality of pixels 60 (see FIG. 3) arranged in respective rows and columns, and a camera 70 in a fixed position in relation to the display 50. The vision system 10 is configured to enable the camera 70 to capture images of the whole display 50 via the mirror 30, and to turn the captured images into image data. In the context of this disclosure “capturing an image” shall be construed broadly to cover any suitable means of obtaining image data comprising information for generating an image.

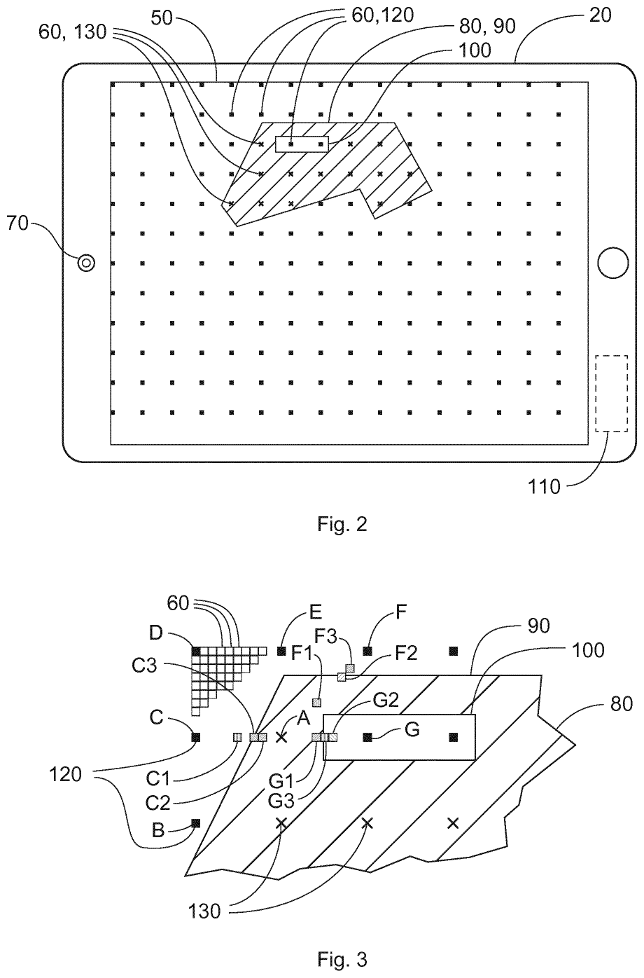

When an object 80 is placed on the display 50 it obstructs some of the pixels 60 from the camera perspective, defining an obstructed area and a corresponding true outline on the display 50. In the present disclosure the term “true outline” refers to real contours 90, 100 (see FIG. 2) of an object 80 from the camera perspective. If all the pixels 60 are illuminated with an appropriate background colour, a contrast between the obstructed area and the remaining display 50 is created, and a vision outline of the object 80 from the camera perspective can be obtained by means of a conventional contour recognition algorithm. In the present disclosure the term “vision outline” refers to contours 90, 100 of an object 80 as perceived by the vision system 10 using a conventional contour recognition algorithm. Factors like lighting conditions, refraction of light and the performance of the contour recognition algorithm may result in certain error between the true outline and the vision outline. It may also not be possible to focus the camera 70 to all areas of the display 50 simultaneously, especially as light from the display 50 to the camera 70 is reflected via a mirror 30, which may be another error factor. As the pixels 60 are very small, such as the largest dimension being in the order of 1/10 mm, the error may have a magnitude of several pixels 60.

On the other hand, even a single pixel 60 highlighted in relation to adjacent pixels 60 can be extracted from the image data. That is, if a single pixel 60 is highlighted, it can be deduced from the image data whether that pixel 60 is visible from the camera perspective or whether it's on the obstructed area and thereby not visible. As the positional relationship between each pixel 60 and the camera 70 is known, an outline of the object 80 can in theory be obtained at one pixel's 60 accuracy based on individual pixels' 60 visibility from the camera perspective. In the present disclosure the term “outline” refers to contours 90, 100 of an object 80 as obtained according to the present invention, the contours comprising all partial contours 90, 100 of an object 80 in relation to the display 50, including an external contour 90 and a possible internal contour or contours 100 implying that the object 80 contains one or more through openings.

In the context of this disclosure the term “highlight” shall be construed broadly to cover any suitable means of providing a pixel 60 or a group of pixels 60 with a high contrast in relation to adjacent pixels 60. This can be achieved e.g., by switching on the pixels 60 to be highlighted while the adjacent pixels 60 are switched off, by switching off the pixels 60 to be highlighted while the adjacent pixels 60 are switched on, or by providing the pixels 60 to be highlighted with a certain colour while the adjacent pixels 60 are provided with a certain different colour. Depending on e.g., the size and light intensity of the pixels 60, highlighting a pixel 60 may involve providing it with a high contrast in relation to adjacent pixels 60 in a relatively large area around it.

Referring to FIG. 2, an object 80 comprising an external contour 90 and one internal contour 100 is placed on a display 50 comprising 1600 rows and 1200 columns of pixels 60. In order to define the outline of the object 80, every tenth pixel 60 along the rows and columns is highlighted, and a first image of the display 50 is captured. A corresponding first image data is saved in a memory 110 within the tablet computer 20. If the dimensions of the object 80 are reasonable in relation to the sizes of the display 50 and the pixels 60, i.e., objects 80 consisting of e.g., very thin shapes being excluded, a plurality of the highlighted pixels 60 will be visible in the first image while the others are not. The pixels 60 that are visible when highlighted are considered as “non-obstructed pixels” 120, and the pixels 60 that are not visible when highlighted are considered as “obstructed pixels” 130. It can immediately be determined that the outline passes between each non-obstructed pixel 120 and each obstructed pixel 130, and already this information would enable defining a coarse outline based on visibility of individual pixels 60. However, it is to be appreciated that in the beginning of the method the knowledge of what pixels 60 are non-obstructed pixels 120 and what pixels 60 are obstructed pixels 130 is quite limited. According to the present example the visibility of only 1% of the pixels 60 can be deduced from the first image data.

Referring to FIG. 3, a magnification of FIG. 2 is shown. In order to define the outline more accurately, the visibility of intermediate pixels 60 between each pair of adjacent non-obstructed and obstructed pixels 120, 130 is checked by highlighting them one by one in an iteration process. For example, the obstructed pixel A is considered to be adjacent to six non-obstructed pixels 120, namely to pixels B, C, D, E, F and G. A second image is captured with pixel C1 highlighted, pixel C1 being the middlemost of the intermediate pixels 60 between the pixels A and C, and it is deduced from second image data that pixel C1 is a non-obstructed pixel 120. A corresponding procedure is repeated for pixels C2 and C3 until a pair of pixels 60 next to each other, in this case C2 and C3, is found of which one is a non-obstructed pixel 120 and the other one is an obstructed pixel 130. The outline can then be determined e.g., to traverse the non-obstructed one of the pair of pixels 60 next to each other, and as a result the outline at the respective location can be defined at one pixel's 60 accuracy.

In the context of this disclosure all pixels 60 that a straight line between the centres of two pixels 60 traverses are to be considered as “intermediate pixels” 60 in relation to the two outermost pixels 60. That is, the straight line does not necessarily need to pass over a centre of a pixel 60 but passing over a part of it is sufficient for the subject pixel 60 being considered as an “intermediate pixel” 60. Moreover, two pixels 60 are considered to lie next to each other if a straight line between the centres of the two pixels 60 does not traverse any other pixel 60.

By determining the visibilities of intermediate pixels 60 between each pair of adjacent non-obstructed and obstructed pixels 120, 130 of the first image, a large number of points of the outline can be defined at one pixel's 60 accuracy. It is to be appreciated that a plurality of these determinations can be made simultaneously. For example, with reference to FIG. 3, the pixels C1, F1 and G1 can be highlighted simultaneously provided that they are not too close to each other. Furthermore, the knowledge of what pixels 60 are non-obstructed and obstructed ones, respectively, increases at each iteration, and the iterations can be continued until the accuracy of the resulting outline is sufficient for the intended purpose. For example, the iterations can be continued until the whole outline is defined with a continuous chain of pixels 60 i.e., at one pixel's 60 accuracy.

There is no reason to highlight pixels 60 whose visibility is already known. That is, once it is established that a pixel 60 is a non-obstructed pixel 120, it should be de-highlighted by removing the contrast in relation to adjacent pixels 60. This is because highlighted pixels 60 potentially disturb the determination of the visibility of the remaining pixels 60 with unknown visibility. De-highlighting a non-obstructed pixel 120 has significance when a pixel 60 with unknown visibility whose visibility is under interest is close to the non-obstructed pixel 120. For example, if a pixel 60 whose visibility is not known lies three pixels 60 away from a non-obstructed pixel 120 (whose visibility is known), it is not possible to highlight the two pixels 60 in relation to each other simultaneously if it cannot be deduced from corresponding image data whether both of the pixels 60 or only one of them is visible.

Also, the pixels 60 that are established to be obstructed pixels 130 should be de-highlighted, even if they don't necessarily cause any disturbance for the determination of the visibility of the remaining pixels 60 (as they are not visible anyway). Disturbing obstructed pixels 130 may be pixels 60 that are on the limit of being visible i.e., pixels 60 that are partially outside of the true outline but not enough for them to be visible in an image; two such pixels 60 close to each other could be visible when highlighted simultaneously, which could lead to erroneous determination of their individual visibility.

As an alternative to the method described hereinbefore, a conventional contour recognition algorithm may be used to first obtain a vision outline of the object 80. Iteration steps corresponding to those described with reference to FIG. 3 can then be concentrated to the vicinity of the outline right from the first iteration cycle such that fewer iteration cycles are needed.

As an alternative to the iteration methods described hereinbefore, the visibility of each and every pixel 60 can be defined by systematically highlighting each of them. For example, following the earlier example, by capturing one hundred images of pixel arrays corresponding to that of FIG. 2, but with different pixels 60 highlighted in each image, it can be determined for each pixel 60 whether it is a non-obstructed or an obstructed one.

The same approach of systematically highlighting each pixel 60 at a time can also be used for checking if any of the pixels 60 is damaged i.e., out of function. This can be done with no object 80 on the display 50, and the display 50 well cleaned, such that every highlighted pixel 60 is visible in an image unless the pixel 60 is damaged.

The invention is not limited to the embodiments shown above, but the person skilled in the art may modify them in a plurality of ways within the scope of the invention as defined by the claims.

1. A method for defining at least a part of an outline of an object, the method comprising the steps of:
placing the object on a display;
highlighting a non-obstructed pixel on the display;
highlighting an obstructed pixel on the display; and
capturing a first image of the display, the non-obstructed pixel being visible in the first image and the obstructed pixel not being visible in the first image;
wherein defining at least a part of the outline based on the location of the non-obstructed pixel alone, based on the location of the obstructed pixel alone, or based on the locations of the non-obstructed pixel and the obstructed pixel.

2. The method according to claim 1 further comprising the step of:
determining that the outline passes between the non-obstructed pixel and the obstructed pixel, or traverses one of the non-obstructed pixel and the obstructed pixel.

3. The method according to claim 1 further comprising the steps of:
de-highlighting the non-obstructed pixel; and
capturing a second image of the display, the obstructed pixel not being visible in the second image.

4. The method according to claim 1, wherein the non-obstructed pixel and the obstructed pixel are next to each other.

5. The method according to claim 1 further comprising the steps of:
highlighting an intermediate pixel between the non and the obstructed pixel;
capturing a third image of the display; and
determining, on the basis of the third image, whether the intermediate pixel is a non-obstructed pixel or an obstructed pixel.

6. The method according to claim 1 further comprising the step of:
defining at least a part of the outline based on the locations of a plurality of non-obstructed pixels alone, based on the locations of a plurality of obstructed pixels alone, or based on the locations of a plurality of non-obstructed pixels and a plurality of obstructed pixels.

7. The method according to claim 1 further comprising the step of:
obtaining a vision outline of the object by means of a conventional contour recognition algorithm.

8. The method according to claim 1 further comprising the steps of:
highlighting, in a sequence including a plurality of operations, all the pixels;
capturing an image of the display during each operation to obtain a plurality of images; and
determining for each pixel, on the basis of the plurality of images, whether it is a non-obstructed pixel or an obstructed pixel.

9. A vision system comprising:
a tablet computer with a display having a plurality of pixels arranged in respective rows and columns, and a camera in a fixed position in relation to the display,
a mirror, and
a fixture defining a fixed relative position between the tablet computer and the mirror,
wherein the vision system is configured to capture images of the display via the mirror.

10. The vision system according to claim 9, configured to capture images of the whole display.

11. A robot system comprising an industrial robot and a vision system comprising:
a tablet computer with a display having a plurality of pixels arranged in respective rows and columns, and a camera in a fixed position in relation to the display,
a mirror, and
a fixture defining a fixed relative position between the tablet computer and the mirror,
wherein the vision system is configured to capture images of the display via the mirror.

12. The method according to claim 2 further comprising the steps of:
de-highlighting the non-obstructed pixel; and
capturing a second image of the display, the obstructed pixel not being visible in the second image.

13. The method according to claim 2, wherein the non-obstructed pixel and the obstructed pixel are next to each other.

14. The method according to claim 2 further comprising the steps of:
highlighting an intermediate pixel between the non-obstructed pixel and the obstructed pixel;
capturing a third image of the display; and
determining, on the basis of the third image, whether the intermediate pixel is a non-obstructed pixel or an obstructed pixel.

15. The method according to claim 2 further comprising the step of:
defining at least a part of the outline based on the locations of a plurality of non-obstructed pixels alone, based on the locations of a plurality of obstructed pixels alone, or based on the locations of a plurality of non-obstructed pixels and a plurality of obstructed pixels.

16. The method according to claim 2 further comprising the step of:
obtaining a vision outline of the object by means of a conventional contour recognition algorithm.

17. The method according to claim 2 further comprising the steps of:
highlighting, in a sequence including a plurality of operations, all the pixels;
capturing an image of the display during each operation to obtain a plurality of images; and
determining for each pixel, on the basis of the plurality of images, whether it is a non-obstructed pixel or an obstructed pixel.
